(19) United States
(12) Patent Application Publication
(10) Pub. No.: US 2024/0216847 A1
(43) Pub. Date: Jul. 4, 2024

(54) OIL FILTER EVACUATOR

(71) Applicant: Baxter Performance, Spokane, WA (US)

(72) Inventor: Kevin Baxter, Spokane, WA (US)

(21) Appl. No.: 18/397,792

(22) Filed: Dec. 27, 2023

Related U.S. Application Data
(60) Provisional application No. 63/436,381, filed on Dec. 30, 2022.
(60) Provisional application No. 63/535,535, filed on Aug. 30, 2023.

(51) Int. Cl. B01D 46/00; B01D 46/68

(52) U.S. Cl. CPC B01D 46/0004; B01D 46/0005; B01D 46/68

(57) ABSTRACT

An oil filter evacuator may be configured to attach to an oil filter housing of a vehicle and/or an oil filter adapter coupled with a vehicle, form a seal with the oil filter housing and/or oil filter adapter, and when an oil filter (such as a spin-on oil filter) is attached to the oil filter housing and/or the oil filter adapter, the oil filter evacuator may be sandwiched between the oil filter housing and/or the oil filter adapter and the oil filter, forming a seal with both the oil filter housing and/or the oil filter adapter and the oil filter. The oil filter evacuator may have a side-hole accessible on an exterior of the oil filter evacuator and extending into a passage of the oil filter evacuator such that pressurized air may be applied to the side-hole and passed into the oil filter system, thereby pressurizing the oil filter system.

### RELATED APPLICATIONS

This application is a Non-Provisional application and claims priority to Provisional Application 63/436,381 filed on Dec. 30, 2022, and Provisional Application 63/535,535 filed on Aug. 30, 2023, both of which are incorporated by reference herein in their entirety.

### BACKGROUND

Vehicles and machinery use oil filters to remove contaminants from engine oil, transmission oil, or lubricating oil. There are two main types of oil filters used for this purpose, cartridge oil filters and spin-on oil filters. Many vehicles and machinery are manufactured to use cartridge oil filters. However, consumers may find spin-on oil filters easier and less messy to replace. Performing oil changes on these vehicles and/or machinery requires that the oil within the system be drained prior to fresh oil being added. Waiting for the oil to drain can be time consuming and inefficient.

### BRIEF DESCRIPTION OF THE DRAWINGS

The detailed description is set forth with reference to the accompanying figures. The use of the same reference numbers in different figures indicates similar or identical items.

FIG. 1A illustrates a perspective view of an example oil filter evacuator.

FIG. 1B illustrates another perspective view of an example oil filter evacuator.

FIG. 1C illustrates another perspective view of an example oil filter evacuator.

FIG. 1D a top view of an example oil filter evacuator.

FIG. 2A illustrates an example oil filter adapter.

FIG. 2B illustrates another example oil filter adapter.

FIG. 3A illustrates a perspective view of an example oil filter evacuator.

FIG. 3B illustrates another perspective view of an example oil filter evacuator.

FIG. 3C illustrates another perspective view of an example oil filter evacuator.

FIG. 3D a top view of an example oil filter evacuator.

FIG. 3E illustrates a cross section of the example oil filter evacuator of FIG. 3D taken along line A-A in FIG. 3D.

FIG. 3F a schematic view of an example removable inner portion of an example oil filter evacuator.

FIG. 3G a schematic view of an example removable inner portion of an example oil filter evacuator.

FIG. 4 illustrates a perspective view of an example oil filter evacuator coupled with an engine viewed from above.

FIG. 5 illustrates an example flow diagram of an example process including utilizing an oil filter evacuator and/or a cylindrical plate.

### DETAILED DESCRIPTION

### Overview

As discussed above, there are two main types of oil filters used in vehicles and machinery today, namely cartridge oil filters and spin-on oil filters. Many vehicles and machinery are manufactured to use cartridge oil filters. Cartridge oil filters may be difficult to access because they are located within an oil filter housing and are usually covered in dirty oil, making them difficult to replace cleanly. Spin-on oil filters are typically easier to access when replacing because they are attached to the exterior of an oil filter housing, and are much cleaner because there is no need to actually touch the filter cartridge within the spin-on cap. Some engines employ oil filter adapters to convert cartridge oil filter systems to spin-on oil filter systems. In all of these oil filter systems, when performing oil changes, it is typically necessary (or at least preferred) to let the old oil completely drain from the system prior to adding in the new oil. Waiting for this old oil to drain can be time consuming and often the old oil does not completely drain (e.g., due to the time required and/or the geometry of the engine, oil filter, and/or oil delivery system) before adding in the new oil, causing excess dirt and sludge build-up in the engine.

This application describes an oil filter evacuator that can be used to quickly and efficiently evacuate oil from an oil filter system, oil delivery system, and/or engine. The oil filter evacuator may be configured to attach to an oil filter housing of a vehicle (which may be integrated in or attached to an engine block) and/or an oil filter adapter coupled with a vehicle, form a seal with the oil filter housing and/or oil filter adapter, and when an oil filter (such as a spin-on oil filter) is attached to the oil filter housing and/or the oil filter adapter, the oil filter evacuator may be sandwiched between the oil filter housing and/or the oil filter adapter and the oil filter, forming a seal with both the oil filter housing and/or the oil filter adapter and the oil filter. The oil filter evacuator may have a port with a valve (e.g., Schrader valve, check valve, etc.) accessible on an exterior of the oil filter evacuator and extending into a passage of the oil filter evacuator such that pressurized air may be applied to the port and passed into the oil filter system, thereby pressurizing the oil filter system and quickly forcing the remaining old oil out of the oil filter system, oil delivery system, and/or portions of the engine during an oil change.

In some embodiments, the oil filter evacuator may include a cylindrical plate having a first side configured to seal against the oil filter housing and/or the oil filter adapter. The first side may include a recessed portion configured to receive a gasket and/or seal such that the gasket and/or seal seals against the oil filter housing and/or the oil filter adapter. The oil filter housing and/or the oil filter adapter may include a threaded portion configured to couple with an oil filter, such as a spin-on oil filter. The threaded portion of the oil filter housing and/or the oil filter adapter may pass through a through-hole of the cylindrical plate and couple with a removable inner portion of the cylindrical plate. For example, the removable inner portion may be configured to fit within the through-hole of the cylindrical plate and couple with the cylindrical plate via a recessed portion of the cylindrical plate around the through-hole and a recessed portion of the removable inner portion around a permitter of the removable inner portion. The removable inner portion may also have a through-hole and a threaded portion lining the inner wall of the through-hole such that the threaded portion lining the inner wall of the through-hole of the removable inner portion may attach to the threaded portion extending from the oil filter housing and/or the oil filter adapter. In this way, when coupling the removable inner portion to the oil filter housing and/or the oil filter adapter, the removable inner portion causes the cylindrical plate to seal against the cylindrical base via a force applied to the cylindrical plate at the recessed portions of the cylindrical plate and the removable inner portion.

Another benefit of the removable inner portion is the ability to turn the cylindrical plate in a 360 degree rotation to “clock” the oil evacuator plate at a desired orientation relative to the oil filter housing and/or the oil filter adapter while securing the oil evacuator plate. For example, engines are often compact with little space to work in and maneuver. When installing a component having an accessible portion, such as a side-hole (sometimes referred to as an air inlet), it is imperative that the component be installed in such a way as to maintain access to the accessible portion while making sure that the component is securely attached to the engine (e.g., oil filter housing and/or the oil filter adapter). As discussed herein, the removable inner portion enables a user to turn the cylindrical plate while tightening the removable inner portion such that the user maintains access to the side-hole as the oil filter evacuator is sealed against the oil filter housing and/or the oil filter adapter.

The oil filter evacuator may be comprised of a variety of different metals, plastics, and/or ceramics. In some examples, the oil filter evacuator may be comprised of billet aluminum, stainless steel, or a combination thereof. Additionally, the oil filter evacuator may be anodized to aid in the process of cleaning and to prevent corrosion and pitting. Each part may be machined or cast, for example. The gaskets and/or seals may be made of rubber, silicone, or other materials that are resistant to the oil to be filtered. In other examples, the oil filter evacuator may be comprised in whole or in part of plastic (e.g., high molecular weight polyethylene, polyether ether ketone, polyetherimide, polytetrafluoroethylene, polybenzimidazole, polydicyclopentadiene, etc.), which may or may not be reinforced with one or more fibers (e.g., carbon fibers, glass fibers, etc.) or inserts (e.g., metal, plastic, ceramic, or carbon inserts). In some examples, if made of a thermoplastic material, the oil filter evacuator (or portion thereof) may be formed by, for example, injection molding. While the following examples of the oil filter evacuator are shown as being cylindrical, in other examples, the oil filter evacuator (or portion thereof) can be other shapes (e.g., having other geometries or cross sections such as rectangular, hexagonal, octagonal, triangular, pentagonal, oval, diamond, heptagonal, octagonal, nonagonal, decagonal, etc.). In some cases, the gasket and/or seal may include an O-ring.

### Example Oil Filter Evacuator

Turning now to the figures, details are provided concerning various example embodiments. In general, the embodiments disclosed in the figures are presented by way of example and should not be construed as limiting the scope of the claims. To the extent that the figures depict dimensions, those dimensions are merely illustrative and oil filter evacuators according to this application may have other dimensions larger or smaller than those depicted herein. The components disclosed in the figures may be combined as desired to create an oil filter evacuator having various configurations. The components disclosed in the figures may be rearranged, modified, duplicated, and/or omitted in some configurations.

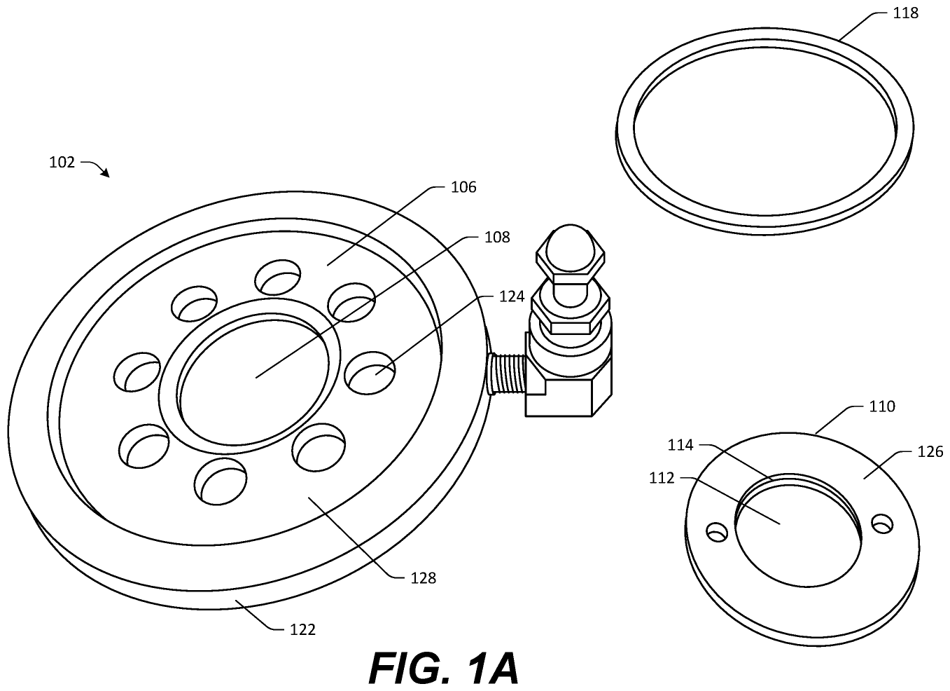

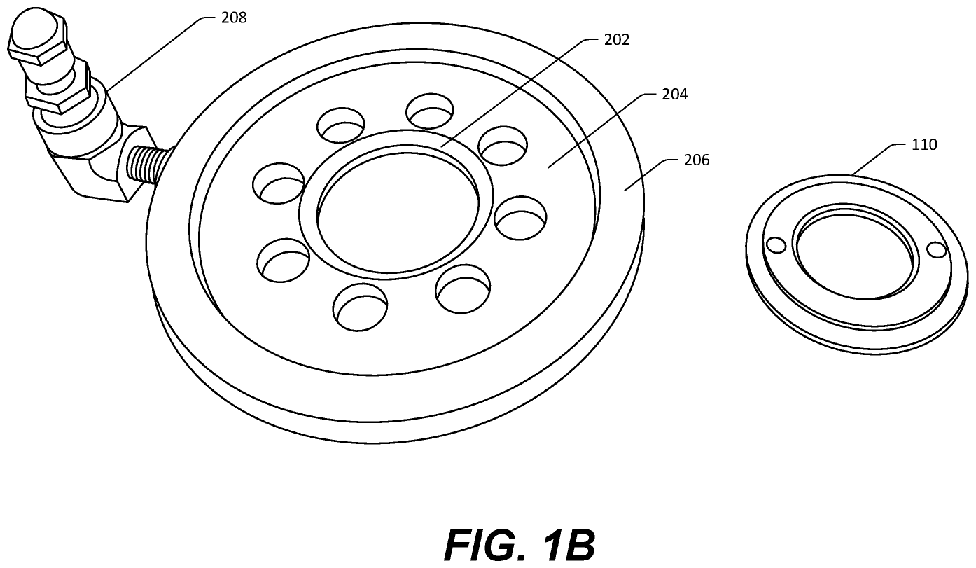

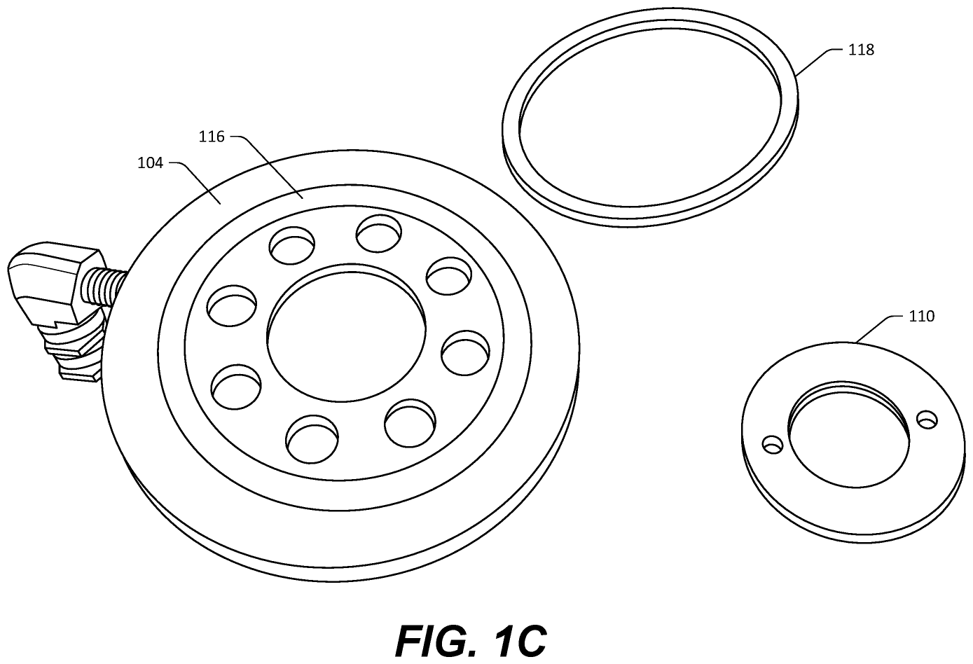

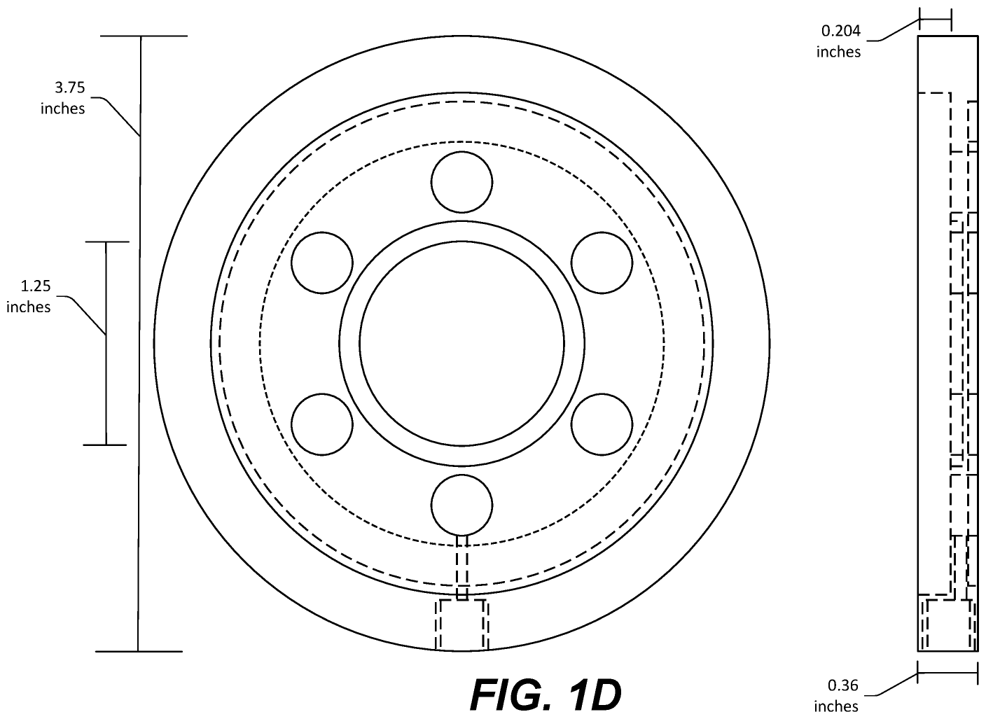

With reference to FIGS. 1A-1C, an example embodiment of an oil filter evacuator may include a cylindrical plate 102 having a first side 104 configured to seal against an oil filter housing and/or an oil filter adapter, such as the oil filter adapter 130. The first side 104 may include a recessed portion 116 configured to receive a gasket and/or seal 118 such that the gasket and/or seal seals against the oil filter housing and/or the oil filter adapter. The oil filter housing and/or the oil filter adapter may include a threaded portion configured to couple with an oil filter, such as a spin-on oil filter. The threaded portion of the oil filter housing and/or the oil filter adapter may pass through a through-hole 108 of the cylindrical plate and couple with a removable inner portion 110 of the cylindrical plate 102. For example, the removable inner portion 110 may be configured to fit within the through-hole 108 of the cylindrical plate 102 and couple with the cylindrical plate 102 via a recessed portion 202 of the cylindrical plate 102 around the through-hole 108 and a recessed portion of the removable inner portion around a permitter of the removable inner portion 110. The removable inner portion 110 may also have a through-hole 112 and a threaded portion 114 lining the inner wall of the through-hole 112 such that the threaded portion 114 lining the inner wall of the through-hole 112 of the removable inner portion 110 may attach to the threaded portion 132 extending from the oil filter housing and/or the oil filter adapter. In this way, when coupling the removable inner portion 110 to the oil filter housing and/or the oil filter adapter, the removable inner portion 110 causes the cylindrical plate 102 to seal against the cylindrical base via a force applied to the cylindrical plate 102 at the recessed portions of the cylindrical plate and the removable inner portion.

FIG. 1D illustrates a schematic illustration of the cylindrical plate 102. For instance, the cylindrical plate 102 may have a width of 0.36 inches. In some examples, the second recessed portion 204 of the second side 106 may be recessed below the rim 206 by 0.204 inches. In some examples, the first through-hole 108 may have a diameter of 1.25 inches. In some examples, the cylindrical plate 102 may have a diameter of 3.75 inches.

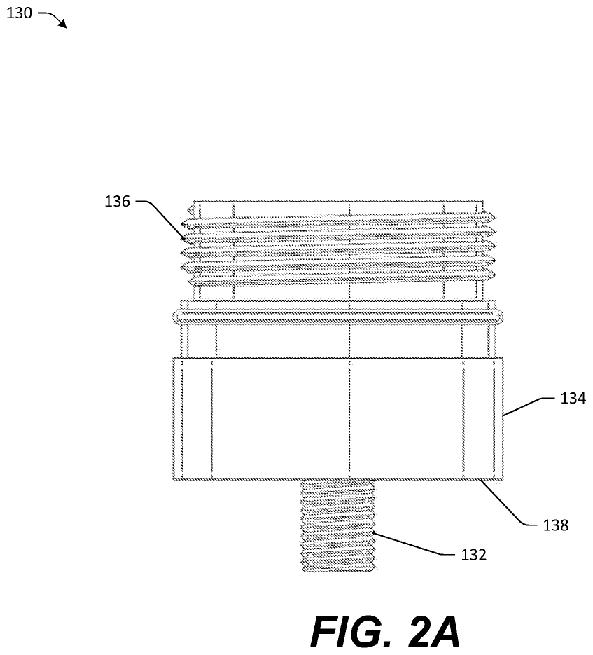

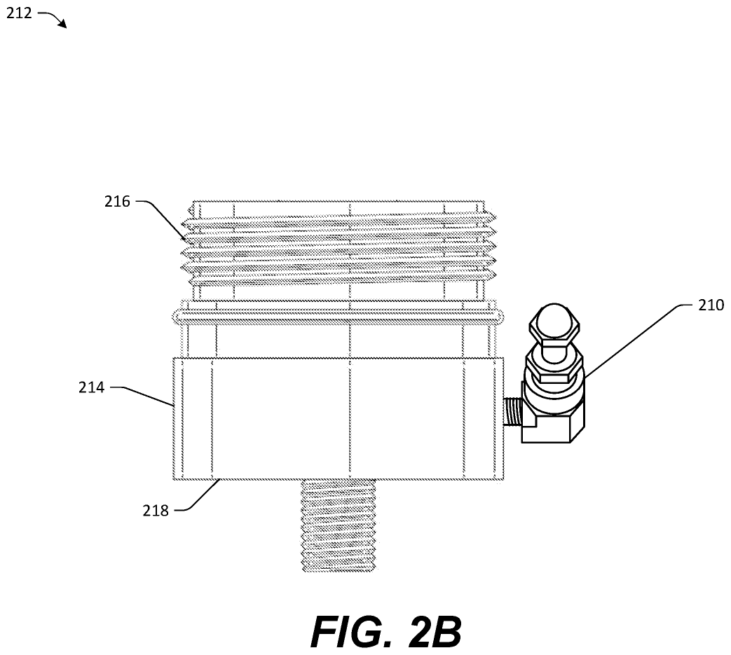

In some cases, the oil filter evacuator may be a component of an oil filter adapter system. For example, FIG. 2A illustrates an oil filter adapter 130 of an oil filter adapter system that may include a cylindrical base 134 having a first end 136 having a threaded portion for coupling to an engine and a second end 138 for coupling to an oil filter. The cylindrical plate 102 may have a first side 104 configured to seal against the second end 138 of the cylindrical base 134 and a second side 106 configured to seal against an oil filter. In some cases, the cylindrical plate 102 may include a first through-hole 108 and a removable inner portion 110 configured to couple with the cylindrical plate 102 via the through-hole 108. In some examples, the removable inner portion 110 may include a second through-hole 112 and a threaded portion 114 of an inner wall of the removable inner portion 110. In some examples, the cylindrical plate 102 may include a recessed portion 116 within a perimeter of the first side 104 and a gasket and/or seal 118 configured to rest inside the recessed portion 116. The cylindrical plate 102 may include a side-hole 120 (e.g., air inlet) extending from an outer wall 122 of the cylindrical plate to an oil passage 124 of the cylindrical plate. For example, when the cylindrical plate 102 is coupled to the oil filter housing and/or the oil filter adapter and an oil filter, un-filtered oil may pass though the oil passage 124 into an oil filter and filtered oil may pass through the through-hole 108 and/or the through hole 112 and back to the oil filter housing and/or the oil filter adapter. The side-hole 120 enables pressurized air to be entered into the oil filter system in order to quickly evacuate the oil from the system during an oil change.

In some examples, the second side 106 of the cylindrical plate may include a first recessed portion 202 configured to receive the removable inner portion 110 and a second recessed portion 204 below a rim 206 of the cylindrical plate 102 such that when the removable inner portion 110 and the cylindrical plate 102 are removably coupled together. For example, this removable coupling allows the cylindrical plate 102 to turn while the removable inner portion 110 is being fixed to the oil filter housing and/or the oil filter adapter. In some cases, a surface 126 of the removable inner portion 110 and a surface 128 of the second recessed portion of the cylindrical plate 102 may be substantially flush when coupled together. That is, the depth of the recessed portion 202 may be substantially the same as a depth of a recessed portion of the removable inner portion.

In some examples, the side-hole 120 may include a threaded portion located on an inner wall of the side-hole 120 such that a valve 208 may be removably coupled to the cylindrical plate via the side-hole 120. As illustrated in FIGS. 1A-1C, the valve 208 is coupled to the side-hole 120 and includes a 90 degree elbow. In some cases, the valve 208 (or another valve) may protrude radially outward and/or may include a different degree of elbow angle (e.g., 0 degree to 180 degree). In some cases, the valve 208 (or another valve) may vary in size and/or may be small enough to fit entirely within the thickness of the cylindrical plate 102 (e.g., flush or recessed within the side-hole 120). In some examples, the valve 208 (or another valve) may be remote from the cylindrical plate 102 (e.g., via a metal and/or plastic tube that extends from the cylindrical plate 102 to a location under a hood of the vehicle). In some examples, the valve 208 (or another valve) may be a manually operable valve (e.g., as opposed to being spring loaded) such as a ball valve, gate valve, and/or a globe valve. In this case, the valve may be continuously movable to any position between fully closed and fully open to control a flowrate through the valve, thereby enabling a user to gradually increase the air pressure/flow applied to the oil filter via the cylindrical plate 102. In some cases, the valve 208 (or another valve) may be electronically controlled (e.g., via a solenoid), such that a user may be enabled to turn air pressure/flow on and off (or to any intermediate position) using an electrical button or other control mechanism and/or computing device. In some examples, the valve 208 (or another valve) and/or the cylindrical plate 102 itself may built directly into an engine block and/or an oil filter base. For instance, the cylindrical plate 102 and/or the valve 208 may be built into the engine block and/or an oil filter base at a time of manufacturing such that the cylindrical plate 102 and/or the valve 208 are accessible to evacuate oil from the engine block and/or oil filter base when they are installed into a vehicle. In some cases, a vehicle may already include an onboard compressor (e.g., used for air suspension or tire inflation) and the cylindrical plate 102 and/or the valve 208 may be fluidly connected to the compressor (e.g., via a tube, hose, pipe, or passage) such that air may be applied to purge the oil filter by pressing a button or other control mechanism to turn air pressure/flow on and off remotely by pressing the button or other control mechanism to open or close a valve (or to any intermediate position) and/or to turn the compressor on or off.

In some examples, the removable inner portion may include a first hole located on a first end of the removable inner portion and a second hole located on a second end of the removable inner portion that is opposite the first end such that a tool may be used to turn the removable inner portion while coupling the removable inner portion to the oil filter housing and/or the oil filter adapter and the threaded portion 114 of the inner wall of the removable inner portion 110 may be coupled to a threaded portion (e.g., threaded portion 132) of the oil filter housing and/or the oil filter adapter.

In some examples, the side-hole may be flush with the outer wall 122 of the cylindrical plate 102. In other examples, the side-hole may extend through an L-shaped turn such that an opening the of side-hole is parallel with the surface 128 of the cylindrical plate 102.

As illustrated in FIG. 1D, the cylindrical plate may include a thin and/or low profile such that a spin-on oil filter may be utilized to thread onto an existing oil filter coupler (e.g., such as on an engine block and/or an oil filter adapter) while the cylindrical plate is also coupled to the oil filter coupler. For instance, the threaded portion 114 of the removable inner portion 110 may couple to a threaded portion of the oil filter coupler of the engine. The oil filter coupler of the engine may have been designed with a threaded portion long enough to couple with a spin-on oil filter. The cylindrical plate 102 and the removable inner portion 110 may have a width (also referred to as a profile) that allows the spin-on oil filter to securely attached to the threads of the oil filter coupler while the cylindrical plate 102 is located between the oil filter coupler and the spin-on oil filter.

FIG. 2B illustrates an oil filter adapter 212 of an oil filter adapter system that may include a cylindrical base 214 having a first end 216 having a threaded portion for coupling to an engine and a second end 218 for coupling to an oil filter. In this example, the oil filter adapter 212 may include a valve 210 directly coupled to the cylindrical base 214 such that pressurized air may be entered into the oil filter system in order to quickly evacuate the oil from the system during an oil change. In some cases, the oil filter adapter 212 may be a remote oil filter adapter and/or a remote oil filter that includes the valve 210 directly coupled to the cylindrical base 214 such that pressurized air may be entered into the oil filter system in order to quickly evacuate the oil from the system during an oil change.

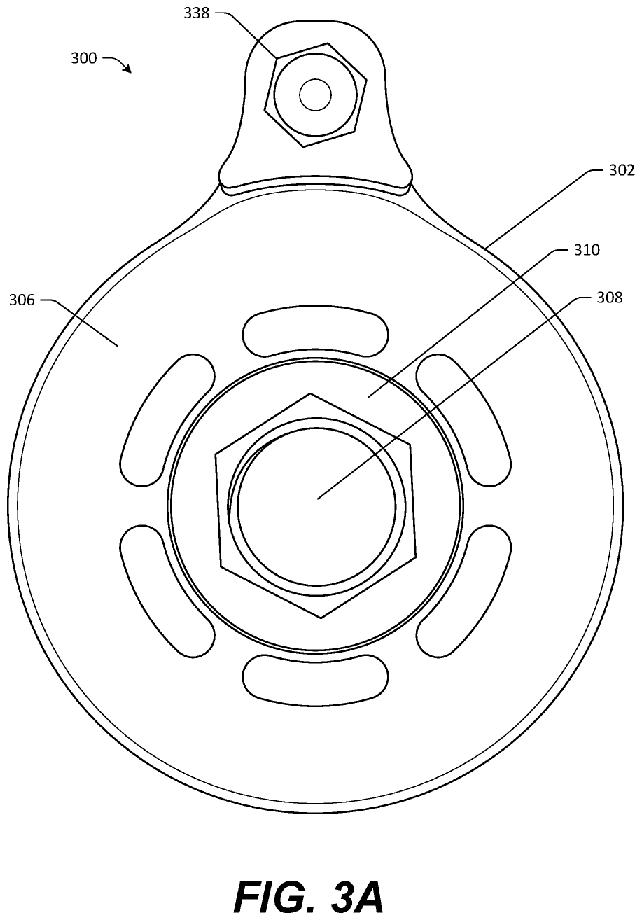

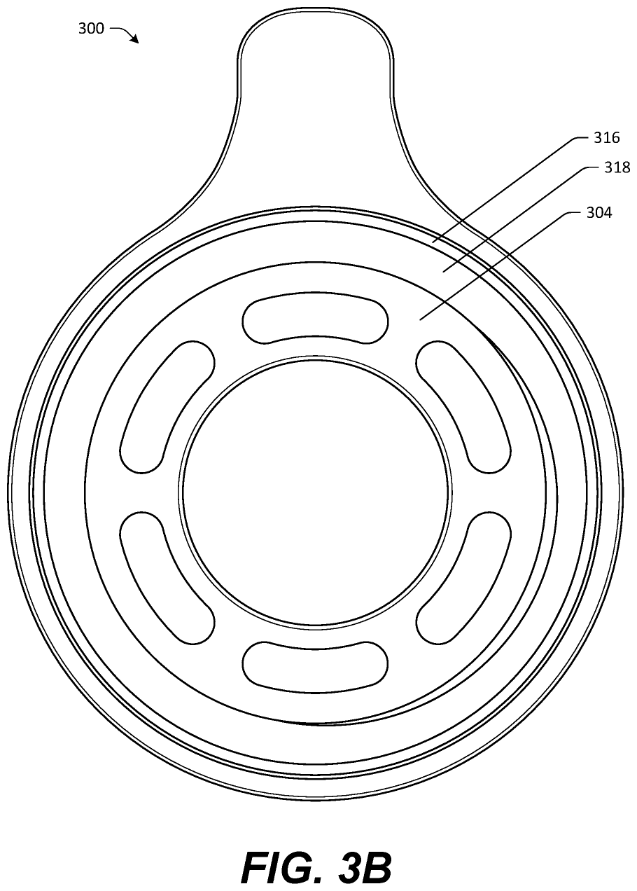

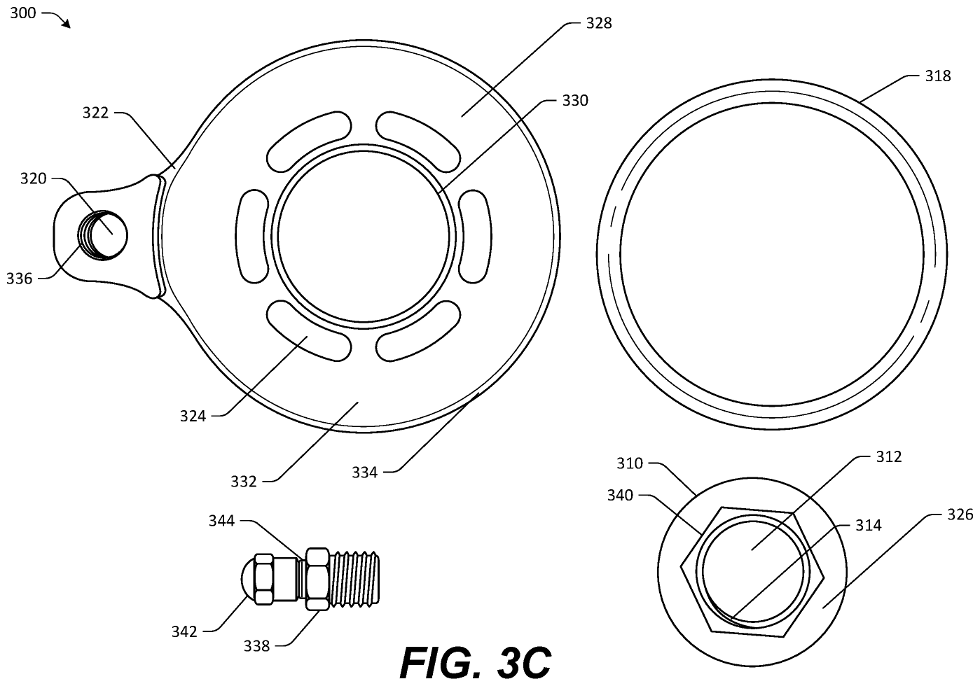

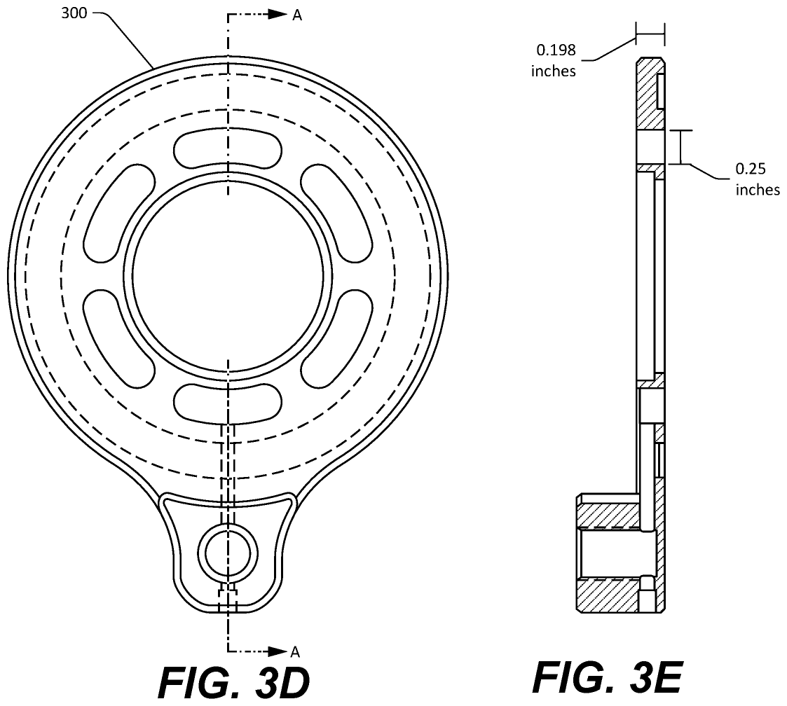

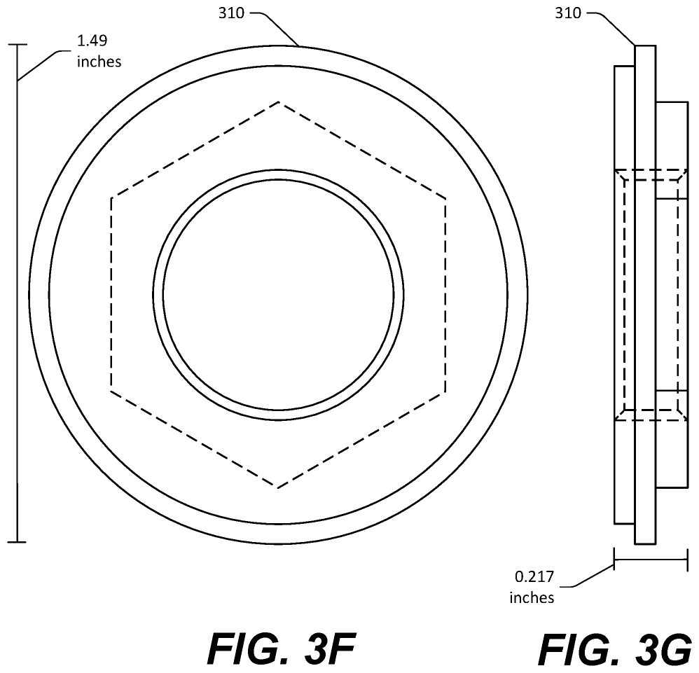

FIGS. 3A-3D illustrate an oil filter evacuator 300 having a cylindrical plate 302, having a first side 304 configured to seal against an oil filter housing and/or an oil filter adapter, such as the oil filter adapter 130. The first side 304 may include a recessed portion 316 configured to receive a gasket and/or seal 318 such that the gasket and/or seal 318 seals against the oil filter housing and/or the oil filter adapter. The oil filter housing and/or the oil filter adapter may include a threaded portion configured to couple with an oil filter, such as a spin-on oil filter. The threaded portion of the oil filter housing and/or the oil filter adapter may pass through a through-hole 308 of the cylindrical plate and couple with a removable inner portion 310 of the cylindrical plate 302. For example, the removable inner portion 310 may be configured to fit within the through-hole 308 of the cylindrical plate 302 and couple with the cylindrical plate 302 via a recessed portion 330 of the cylindrical plate 302 around the through-hole 308 and a recessed portion of the removable inner portion around a permitter of the removable inner portion 310. The removable inner portion 310 may also have a through-hole 312 and a threaded portion 314 lining the inner wall of the through-hole 312 such that the threaded portion 314 lining the inner wall of the through-hole 312 of the removable inner portion 310 may attach to the threaded portion 132 extending from the oil filter housing and/or the oil filter adapter. In this way, when coupling the removable inner portion 310 to the oil filter housing and/or the oil filter adapter, the removable inner portion 310 causes the cylindrical plate 302 to seal against the cylindrical base via a force applied to the cylindrical plate 302 at the recessed portions of the cylindrical plate and the removable inner portion.

As illustrated in FIGS. 3A-3C, the valve 338 is coupled to the side-hole 320 (e.g., air inlet) and extends 90 degrees relative to a surface 328. In some cases, the valve 328 (or another valve) may protrude radially outward and/or may include a different degree of elbow angle (e.g., 0 degree to 180 degree). In some cases, the valve 328 (or another valve) may vary in size and/or may be small enough to fit entirely within the thickness of the cylindrical plate 302 (e.g., within the side-hole 320). In some examples, the valve 328 (or another valve) may be remote from the cylindrical plate 302 (e.g., via a metal and/or plastic tube that extends from the cylindrical plate 302 to a location under a hood of the vehicle). In some examples, the valve 328 (or another valve) may be a manually operable valve (e.g., as opposed to being spring loaded) such as a ball valve, gate valve, and/or a globe valve. In this case, the valve may be continuously movable to any position between fully closed and fully open to control a flowrate through the valve, thereby enabling a user to gradually increase the air pressure/flow applied to the oil filter via the cylindrical plate 302. In some cases, the valve 328 (or another valve) may be electronically controlled (e.g., via a solenoid), such that a user may be enabled to turn air pressure/flow on and off (or to any intermediate position) using an electrical button or other control mechanism and/or computing device. In some examples, the valve 328 (or another valve) and/or the cylindrical plate 302 itself may built directly into an engine block and/or an oil filter base. For instance, the cylindrical plate 302 and/or the valve 328 may be built into the engine block and/or an oil filter base at a time of manufacturing such that the cylindrical plate 302 and/or the valve 328 are accessible to evacuate oil from the engine block and/or oil filter base when they are installed into a vehicle. In some cases, a vehicle may already include an onboard compressor (e.g., used for air suspension or tire inflation) and the cylindrical plate 302 and/or the valve 328 may be fluidly connected to the compressor (e.g., via a tube, hose, pipe, or passage) such that air may be applied to purge the oil filter by pressing a button or other control mechanism to turn air pressure/flow on and off remotely by pressing the button or other control mechanism to open or close a valve (or to any intermediate position) and/or to turn the compressor on or off.

In some cases, the oil filter evacuator 300 may be a component of an oil filter adapter system. For example, FIG. 2A is discussed above and illustrates an oil filter adapter 130 of an oil filter adapter system that may include a cylindrical base 134 having a first end 136 having a threaded portion for coupling to an engine and a second end 138 for coupling to an oil filter. The cylindrical plate 302 may have a first side 304 configured to seal against the second end 138 of the cylindrical base 134 and a second side 306 configured to seal against an oil filter. In some cases, the cylindrical plate 302 may include a first through-hole 308 and a removable inner portion 310 configured to couple with the cylindrical plate 302 via the through-hole 308. In some examples, the removable inner portion 310 may include a second through-hole 312 and a threaded portion 314 of an inner wall of the removable inner portion 310. In some examples, the cylindrical plate 302 may include a recessed portion 316 within a perimeter of the first side 304 and a gasket and/or seal 318 configured to rest inside the recessed portion 316. The cylindrical plate 302 may include a side-hole 320 extending from an outer wall 322 of the cylindrical plate to an oil passage 324 of the cylindrical plate. For example, when the cylindrical plate 302 is coupled to the oil filter housing and/or the oil filter adapter and an oil filter, un-filtered oil may pass though the oil passage 324 into an oil filter and filtered oil may pass through the through-hole 308 and/or the through hole 312 and back to the oil filter housing and/or the oil filter adapter. The side-hole 320 enables pressurized air to be entered into the oil filter system in order to quickly evacuate the oil from the system during an oil change. Although the side-hole 320 is illustrated as being located facing a same direction as the second side 306, it is to be understood that the side-hole 320 may face any directions, such as a same direction as the first side 304 and/or a direction facing in a same plane as the cylindrical plate 302 (e.g., facing out of the side wall of the cylindrical plate 302.

In some examples, the second side 306 of the cylindrical plate may include a first recessed portion 330 configured to receive the removable inner portion 310 and a second recessed portion 332 below a rim 334 of the cylindrical plate 302 such that when the removable inner portion 310 and the cylindrical plate 302 are removably coupled together. For example, this removable coupling allows the cylindrical plate 302 to turn while the removable inner portion 310 is being fixed to the oil filter housing and/or the oil filter adapter. In some cases, a surface 326 of the removable inner portion 310 and the surface 328 of the second recessed portion of the cylindrical plate 302 may be substantially flush when coupled together. That is, the depth of the recessed portion 330 may be substantially the same as a depth of a recessed portion of the removable inner portion 310 such that they fit together.

In some examples, the side-hole 320 may include a threaded portion 336 located on an inner wall of the side-hole 320 such that a valve 338 may be removably coupled to the cylindrical plate via the side-hole 320. In some examples, the valve 338 may include a Schrader valve. In some examples, the valve 338 may include other types of valves. In some cases, the valve 338 and/or the side-hole 320 may be configured to couple with a hose such that pressurized air may be applied to the cylindrical plate via the side-hole 320 remotely

In some examples, the removable inner portion 310 may include a hex-shaped protrusion 340 (e.g., a lock nut) such that a tool (e.g., a socket) may be used to turn the removable inner portion 310 while coupling the removable inner portion 310 to the oil filter housing and/or the oil filter adapter and the threaded portion 314 of the inner wall of the removable inner portion 310 may be coupled to a threaded portion (e.g., threaded portion 132) of the oil filter housing and/or the oil filter adapter.

FIG. 3D illustrates a schematic illustration of the oil filter evacuator 300. For instance, the cylindrical plate 302 of the oil filter evacuator 300 may have a width of 0.198 inches. In some examples, the oil passages (e.g., such as oil passage 324) may have a width of 0.25 inches.

FIG. 3E illustrates a side cross-sectional view oil filter evacuator 300 taken along a line A-A from FIG. 3D.

FIG. 3F illustrates a schematic illustration of the removable inner portion 310 of the oil filter evacuator 300. For instance, the removable inner portion 310 may have a diameter of 1.49 inches.

FIG. 3G illustrates a schematic illustration of a side view of the removable inner portion 310 of the oil filter evacuator 300. For instance, the removable inner portion 310 may have a diameter of 1.49 inches.

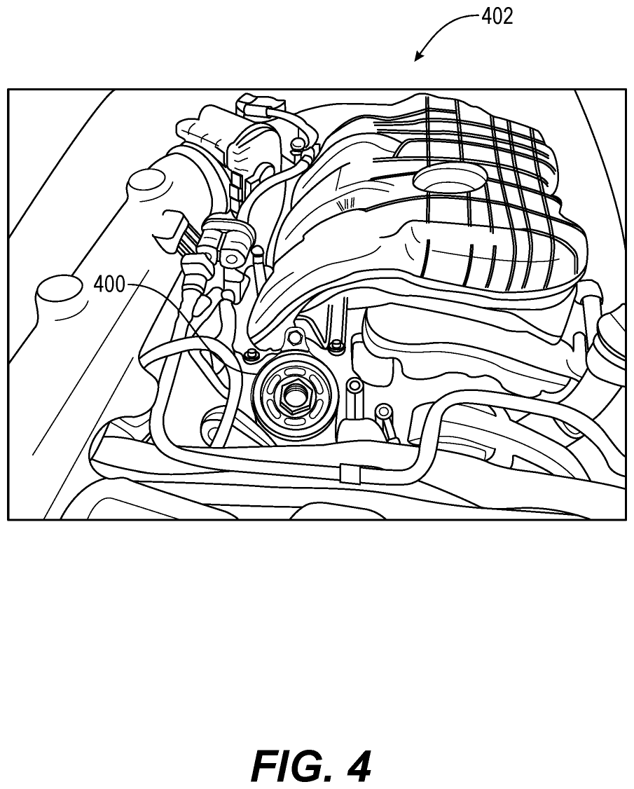

FIG. 4 illustrates an oil filter evacuator 400 built directly into an engine block 402. For instance, the oil filter evacuator 400 may be built into the engine block 402 (e.g., machined, cast, or otherwise formed directly into an engine block) and/or an oil filter base (e.g., a separate plate, housing, or other component configured to receive an oil filter that couples to the engine) at a time of manufacturing such that the oil filter evacuator 400 are accessible to evacuate oil from the engine block 402 and/or oil filter base when they are installed into a vehicle. In some cases, a vehicle may already include an onboard compressor (e.g., used for air suspension or tire inflation) and the oil filter evacuator 400 and/or a valve of the oil filter evacuator 400 may be fluidly connected to the compressor (e.g., via a tube, hose, pipe, or passage) such that air may be applied to purge the oil filter by pressing a button or other control mechanism to turn air pressure/flow on and off remotely by pressing the button or other control mechanism to open or close a valve (or to any intermediate position) and/or to turn the compressor on or off.

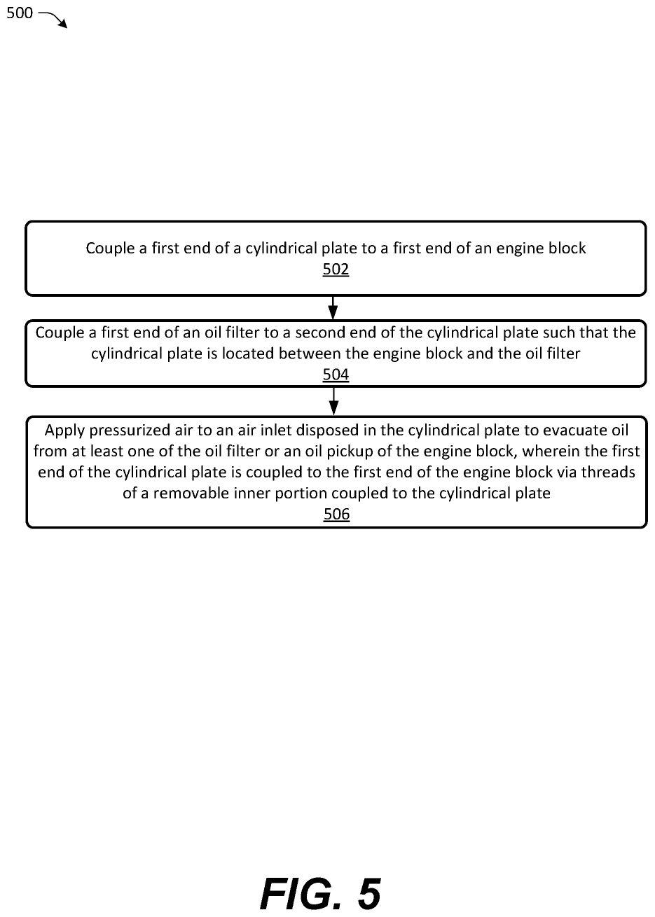

FIG. 5 illustrates an example flow diagram of an example process 500 that includes utilizing an oil filter evacuator and/or a cylindrical plate. The order in which the operations or steps are described is not intended to be construed as a limitation, and any number of the described operations may be combined in any order and/or in parallel to implement process 500. The operations described with respect to the process 500 are described as being performed by an oil filtration system. However, it should be understood that some or all of these operations may be performed by some or all of components, devices, and/or systems described herein.

At block 502, the process 500 may include coupling a first end of a cylindrical plate to a first end of an engine block.

At block 504, the process 500 may include coupling a first end of an oil filter to a second end of the cylindrical plate such that the cylindrical plate is located between the engine block and the oil filter.

At block 506, the process 500 may include applying pressurized air to an air inlet disposed in the cylindrical plate to evacuate oil from at least one of the oil filter or an oil pickup of the engine, wherein the first end of the cylindrical plate is coupled to the first end of the engine block via threads of a removable inner portion coupled to the cylindrical plate.

Additionally, or alternatively, the process 500 may include rotating, prior to coupling the first end of the oil filter to the second end of the cylindrical plate, the cylindrical plate such that the removable inner portion remains fixed to the engine block while the cylindrical plate rotates.

Additionally, or alternatively, the process 500 may include the second side of the cylindrical plate including a first recessed portion configured to receive the removable inner portion and a second recessed portion below a rim of the cylindrical plate such that when the removable inner portion and the cylindrical plate are coupled together, a surface of the removable inner portion and a surface of the second recessed portion of the cylindrical plate are substantially flush.

Additionally, or alternatively, the process 500 may include the side-hole including a threaded portion located on an inner wall of the side-hole.

Additionally, or alternatively, the process 500 may include the threaded portion of the side-hole being configured to couple with an air inlet valve.

Additionally, or alternatively, the process 500 may include the removable inner portion including a first hole and a second hole located on opposite sides of the second through-hole.

Additionally, or alternatively, the process 500 may include the cylindrical plate being configured to rotate in a 360 degree range relative to an engine block prior to the removable inner portion being secured to the engine block in a fixed position.

Additionally, or alternatively, the process 500 may include rotating, prior to coupling the first end of the oil filter to the second end of the cylindrical plate, the cylindrical plate ins a 360 degree range such that the removable inner portion remains fixed to the engine block while the cylindrical plate rotates.

### CONCLUSION

Although the disclosure describes embodiments having specific structural features and/or methodological acts, it is to be understood that the claims are not necessarily limited to the specific features or acts described. Rather, the specific features and acts are merely illustrative of some embodiments that fall within the scope of claims of the application.

What is claimed is:

1. A system comprising:
a cylindrical plate having a first side and a second side, the cylindrical plate including:
a first through-hole;
a recessed portion within a perimeter of the first side and seal configured to rest inside the recessed portion; and
a side-hole extending from an outer wall of the cylindrical plate to a filtered oil passage of the cylindrical plate; and
a removable inner portion configured to couple with the cylindrical plate via the first through-hole, the removable inner portion including a second through-hole and a threaded portion of an inner wall of the removable inner portion.

2. The system of claim 1, wherein the second side of the cylindrical plate includes a first recessed portion configured to receive the removable inner portion and a second recessed portion below a rim of the cylindrical plate such that when the removable inner portion and the cylindrical plate are coupled together, a surface of the removable inner portion and a surface of the second recessed portion of the cylindrical plate are substantially flush.

3. The system of claim 1, wherein the side-hole includes a threaded portion located on an inner wall of the side-hole, the threaded portion of the side-hole being configured to couple with an air inlet valve.

4. The system of claim 1, wherein the removable inner portion includes a first hole and a second hole located on opposite sides of the second through-hole.

5. The system of claim 1, wherein the threaded portion of the inner wall of the removable inner portion is configured to be coupled to a threaded portion of an engine block.

6. The system of claim 1, wherein the removable inner portion is configured to thread onto an engine block such that the cylindrical plate to seals against the engine block via a force applied to the cylindrical plate at the first recessed portion from the removable inner portion.

7. The system of claim 1, wherein the side-hole of the cylindrical plate is configured to receive air and to pass the air, via the filtered oil passage, to force oil out of an oil filter when the cylindrical plate is coupled to an engine.

8. The system of claim 1, wherein the cylindrical plate is configured to be interposed between an engine block and an oil filter.

9. A method performed by a system comprising:
coupling a first end of a cylindrical plate to a first end of an engine block;
coupling a first end of an oil filter to a second end of the cylindrical plate such that the cylindrical plate is located between the engine block and the oil filter; and
applying pressurized air to an air inlet disposed in the cylindrical plate to evacuate oil from at least one of the oil filer or an oil pickup of the engine,
wherein the first end of the cylindrical plate is coupled to the first end of the engine block via threads of a removable inner portion coupled to the cylindrical plate.

10. The method of claim 9, further comprising rotating, prior to coupling the first end of the oil filter to the second end of the cylindrical plate, the cylindrical plate such that the removable inner portion remains fixed to the engine block while the cylindrical plate rotates.

11. The method of claim 10, wherein a second side of the cylindrical plate includes a first recessed portion configured to receive the removable inner portion and a second recessed portion below a rim of the cylindrical plate such that when the removable inner portion and the cylindrical plate are coupled together, a surface of the removable inner portion and a surface of the second recessed portion of the cylindrical plate are substantially flush.

12. The method of claim 10, wherein the air inlet includes a threaded portion located on an inner wall of the air inlet.

13. The method of claim 12, wherein the threaded portion of the air inlet is configured to couple with an air inlet valve.

14. The method of claim 9, wherein the removable inner portion includes a first hole and a second hole located on opposite sides of a second through-hole.

15. A system comprising:
a cylindrical plate having a first side and a second side, the cylindrical plate including:
a first through-hole;
a recessed portion within a perimeter of the first side; and
a side-hole extending from an outer wall of the cylindrical plate to a passage of the cylindrical plate; and
a removable inner portion including a second through-hole and a threaded portion of an inner wall of the removable inner portion.

16. The system of claim 15, wherein the second side of the cylindrical plate includes a first recessed portion configured to receive the removable inner portion and a second recessed portion below a rim of the cylindrical plate such that when the removable inner portion and the cylindrical plate are coupled together, a surface of the removable inner portion and a surface of the second recessed portion of the cylindrical plate are substantially flush.

17. The system of claim 15, wherein the side-hole includes a threaded portion located on an inner wall of the side-hole.

18. The system of claim 17, wherein the threaded portion of the side-hole is configured to couple with an air inlet valve.

19. The system of claim 15, wherein the removable inner portion includes a first hole and a second hole located on opposite sides of the second through-hole.

20. The system of claim 15, wherein the cylindrical plate has thickness between 0.3 inches and 0.4 inches.
